(19) United States
(12) Patent Application Publication
(10) Pub. No.: US 2012/0284200 A1
(43) Pub. Date: Nov. 8, 2012

(54) SYSTEM FOR COMPUTERIZED MANAGEMENT OF PATENT-RELATED INFORMATION

(76) Inventor: Brad Pedersen, Minneapolis, MN (US)

(21) Appl. No.: 13/465,745

(22) Filed: May 7, 2012

Related U.S. Application Data
(60) Provisional application No. 61/483,530, filed on May 6, 2011.

(51) Int. Cl. G06Q 50/00

(52) U.S. Cl. 705/310

(57) ABSTRACT

Systems and methods for the computerized management of patent information. Various computer-implemented methods and apparatuses provide a more intuitive and meaningful visual representation of key aspects relating to the patent prosecution normally encountered with respect to the management of the prosecution of multiple patent cases. In an embodiment, the system provides a visual representation of each individual patent family within the viewed set or subset of families. In an embodiment, the system provides a visual representation of the relative timeline of the progress of a particular patent case. In an embodiment, the system provides a visual representation of the budget and cost information associated with at least some of the events on the timeline representation of a given case. In an embodiment, the system provides a visual representation of the relative status of any one application.

### RELATED APPLICATION

The present application claims the benefit of U.S. Provisional Application No. 61/483,530 filed May 6, 2011, which is incorporated herein in its entirety by reference.

### FIELD OF THE INVENTION

The present invention relates generally to data processing, including automated computerized business practice and management systems. More particularly, the present invention relates to a computerized system for intellectual property management of patent-related information.

### BACKGROUND OF THE INVENTION

The problem of how to manage data about one's business has existed since business records were first kept. A whole field of technology called Business Intelligence (BI) has emerged to provide applications and technologies for gathering, storing, analyzing, and providing data to decision-makers in order to make better business decisions. Decision Support Systems (DSS), a type of BI, have been around, in some form, since the 1960's. A DSS generally describes a computer-based system used to support business or organizational decision-making activities.

With recent advancements in personal computers, servers, and software programming languages that allow for detailed graphical user interfaces, as well as the networking capacity to handle the interaction between these components, the ability to measure, store, and format complex metrics has increased dramatically. These advancements have given rise to a type of DSS called Executive Information Systems (EIS) that provide decision-makers access to internal and external information in formatted, easy-to-use interfaces, rather than overwhelming them with the details of the collected data. Depending on the application, some EISs meet business needs by not only providing snapshots of the big picture in formatted, easy-to-use interfaces, but also offer details in a so-called “drill down” format as needed.

Dashboard displays are increasingly used as the primary graphical display component of an EIS. While modern dashboards can handle display and presentation of certain type of data extremely well, such as aggregated summary or trend data, current dashboards are seriously lacking in other respects. Dashboards are good for representing aggregate measurements like, for example, quarterly sales data. One example of the use of aggregated summary and trend data can be found at http://www.uspto.gov/dashboards/patents/main.dashxml which provides the USPTO's “Data Visualization Center” dashboard display of pendency information, as well as critical USPTO performance indicators like backlog, production, actions per disposal, and staffing levels, etc. in a dashboard format. Another example of the use of summary-type dashboards is described in U.S. Publication No. 2010/0262512A1, in which trademark and copyright data from various sources like Internet usage (online auction sites) and shipping data from sea, air, and land ports is collected, aggregated and finally displayed so that a brand manager can readily see how a trademark or copyright is being used, presented, or advertised, etc., around the world. Summarizing trademark or copyright data as an aggregate measure is completely appropriate because, in this context, it is overall usage that the user is concerned about.

However, in the context of patent prosecution, the current types of reporting dashboards fall short. While aggregated summaries and trends displayed by current types of dashboards can provide an overall picture of a given patent portfolio, the details of the patent prosecution of any given patent application end up being displayed in some type of column-grid report that presents voluminous amounts of data and requires significant expertise to interpret. This type of individual case reporting is typically driven by docketing due dates that are tracked for each patent application as the application progresses through the multi-year process of being examined by the Patent Office. It is crucial that these deadlines are recognized and adhered to, because serious consequences can result, like extension fees or even abandonment of an application for a failure to meet a due date. U.S. Publication Nos. 2002/0093528A1 and 2006/0212302A1, and U.S. Pat. Nos. 6,499,026 and 6,549,894 show various examples of the current types of column-grid report user-interfaces that are used for managing patent portfolios.

One of the reasons why patent user interfaces have resorted to a column-grid type of display is that the cycle of prosecution communications back and forth with the Patent Office creates a reactionary form of deadline that is not controlled by, or even predictable by, the party operating the patent management system. Accordingly, any kind of prosecution management system must kept track of and be flexible and responsive to these asynchronous communications. Thus, the triggering event in the patent system is both reactionary and dictated. In addition to the asynchronous nature of the deadline events, another reason why patent management systems are unique and not adaptable to other kinds of existing dashboard techniques relates to the uncertain nature of the tasks that may be required in response to a given communication. Whether some or all of the patent claims are allowed or rejected will dictate what kind of next steps are available in the process of prosecuting the patent application. Again, the complexities and uncertainties inherent in the patent prosecution process do not lend themselves to use of traditional dashboard type of user interfaces as part of an automated patent management system.

It can be seen that these challenges are complicated enough for management of small numbers of patent applications for a given client, and become overwhelming and unmanageable when there are large numbers of patent applications and/or patent applications being prepared and prosecuted for multiple numbers of different clients. What is needed is a computerized system for intellectual property management of patent-related information that provides for better user-interfaces and techniques for manipulating and displaying data for patent-related information.

### SUMMARY OF THE INVENTION

The present invention is a system for computerized management of patent information that includes various computer-implemented methods and apparatus for providing a more intuitive and meaningful visual representation of key aspects relating to the patent prosecution normally encountered with respect to the management of the prosecution of multiple patent cases.

In an embodiment, the system provides a visual representation of each individual patent family within the viewed set or subset of families. The familial visual representation may include features that allow a user to clickably expand or contract the individual applications or granted patents within the family, and to recursively further expand or contract families within a family. Additionally, the familial visual representation may include features that allow for a “zoomable” view of the families. This allows the user to visually see what the larger family tree looks like, as well as any smaller portion of the tree, if desired. The familial visual representation can be an icon. In an embodiment, international applications associated with a U.S. family are also depicted. In embodiments of the system, a home country can be selected such that applications or granted patents of countries outside the home country are depicted in the familial visual representation as “foreign” applications. A familial visual representation like this solves the problem of not knowing, and subsequently having to research via text-based sources, the familial history of a particular application. A graphical interface based on these kinds of familial visual representations can provide the prosecutor, patent manager or business executive with a quick, high-level view of the number of patents.

In an embodiment, the system provides a visual representation of the relative timeline of the progress of a particular patent case, either as a pending patent application, an issued patent or a patent undergoing some form of post-issuance proceeding. Once an individual family member or case is selected by the user via the familial representation field, a timeline showing the relative progress of that case is displayed. The timeline captures current and past actions with timeframes for completion or practitioner action, expected timeframes for future actions, and any other key reactionary or dictated events or milestones. Further, multiple individual timelines can be displayed by the system. Using the timeline(s), the user can visually “see” the relative progress of an individual case or of some or all of the members of a given family of cases. For example, an individual timeline may show a recently-received Office Action as an event. In an embodiment, the system could include a shaded future area as the timeframe for response to the Office Action and end at the deadline for response. This form of computerized presentation can aid a practitioner or portfolio manager in helping plan workloads, report status, and plan budgets and expenses. Based on this timeline and the timelines of other cases, the practitioner and/or portfolio manager is better able to make decisions on what application requires immediate attention, rather than looking up and manually comparing docket deadline dates. More importantly, the practitioner and/or portfolio manager is presented with a computer generated display that provides an easily digestible presentation of the information needed to get an intuitive sense of the progress and status of a given case or family of cases.

In an embodiment, the system provides a visual representation of the budget and cost information associated with at least some of the events on the timeline representation of a given case. In one embodiment, for each event, a “thermometer-style” or other visual indication of the relative cost for that event can be displayed. In one embodiment, budget values can be preset or entered into the system and the cost representation can uses colors and/or elongated bar-chart progress indications to visually depict to the progress of the event relative to the budget.

In an embodiment the system provides a visual representation of the relative status of any one application. The status can be nearly any useful visual illustration like an informative word, color marking, or informative symbol, or any combination thereof. In the patent prosecution context, it is useful to utilize a matrix of basic patent progress in combination with a red-yellow-green color scheme to indicate relative status. For example, in the basic patent progress categories “Preparation,” “Pending,” “Issued,” “Appeal,” “Contested,” and “Expired,” a yellow fill of the “Pending” field might indicate that an Office Action was recently received and action is required by the practitioner. In another example, a green fill of the “Issued” field might indicate that the application has been issued. In yet another example, a red fill of the “Appeal” field might indicate that practitioner response for an aspect of the appeal is past due or requires the practitioner's immediate attention. These indications thus provide yet more useful data to the practitioner for his decision-making activities.

The above-described features are all directed towards facilitating the computerized management of a patent portfolio that includes multiple patent cases in a way that enhances the human ability to understand, manage, and monitor cases where the triggering event for actions and deadlines in the cases is asynchronous and is also both reactionary and dictated. Unlike existing EIS dashboards, the system does not aggregate or average patent data. Nor does the system merely provide data on a single case. Rather, the system provides the ability to manage numerous individual files by incorporating the key pieces of data relevant to patent prosecution and portfolio management of multiple applications in a unified view on a computerized display.

The above summary of the invention is not intended to describe each illustrated embodiment or every implementation of the present invention. The detailed description and claims that follow more particularly exemplify these embodiments.

### BRIEF DESCRIPTION OF THE DRAWINGS

FIGS. 1A and 1B illustrate contexts in which the system of the present invention may be utilized;

FIG. 2 is a diagram of a system for computerized management of patent-related information, according to an embodiment of the present invention;

FIG. 3 is a graphical user interface of a dashboard according to an embodiment of the present invention.

FIG. 4 is an information flow diagram illustrating the exchange of information of the system of FIG. 2, according to an embodiment of the present invention;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims and their equivalents.

The invention may be embodied in other specific forms without departing from the essential attributes thereof; therefore, the illustrated embodiments should be considered in all respects as illustrative and not restrictive.

### DETAILED DESCRIPTION OF THE DRAWINGS

The following detailed description includes references to the accompanying drawings, which form a part of the detailed description. The drawings show, by way of illustration, specific embodiments in which the present subject matter may be practiced. These embodiments, which are also referred to herein as “examples,” are described in enough detail to enable those skilled in the art to practice the present subject matter. The embodiments may be combined, other embodiments may be utilized, or structural, logical, and electrical changes may be made without departing from the scope of the present subject matter. The following detailed description is, therefore, not to be taken in a limiting sense, and the scope of the present subject matter is defined by the amended claims and their equivalents.

A system for computerized management of patent-related information that is the subject of this application may be useful in a number of different contexts. For most practitioners practicing in a law firm or portfolio managers working for a company, the number of individual cases entrusted to that person will be significant and can be spread across a single technology or multiple technology areas, but most often the number of cases is not likely to be more than a thousand and the number of technology fields is typically less than a hundred. Thus, embodiments of the system can allow for the graphical display of all cases from a single technology silo, a single company, or even a single department or subsidiary within a company, or the system can enable the display of selected cases from multiple technology silos, multiple companies or multiple departments or subsidiaries within a given company where the cases displayed include all of the cases across the multiple areas, or only selected cases based on applied filters or criteria.

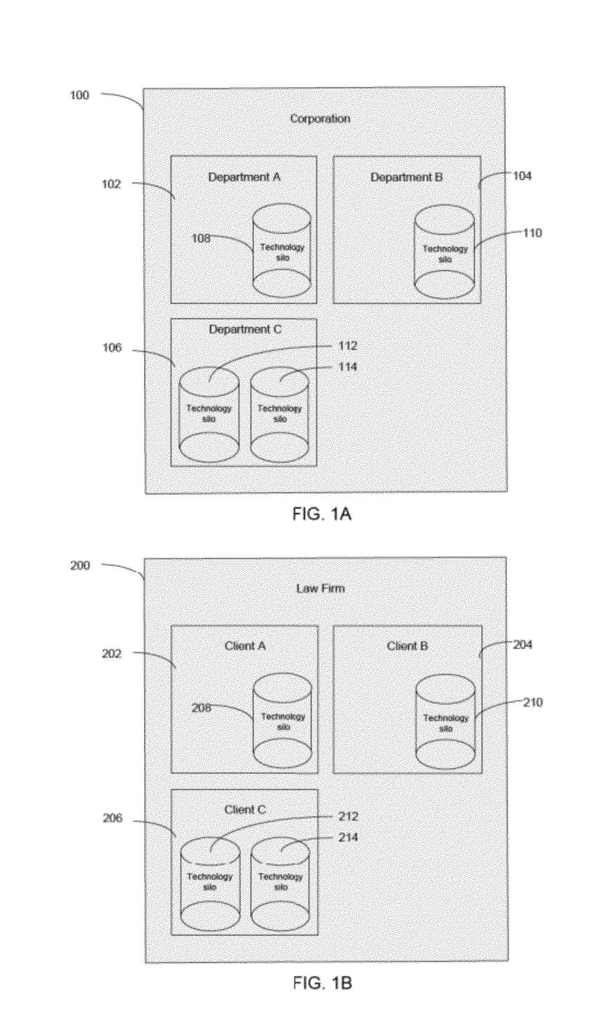

Referring to FIG. 1A, an embodiment of the system of the present invention can be used with respect to the patent rights of a corporation 100 organized internally along product lines or technology may have a number of separate, discrete departments. Department A 102 may manufacture or sell a different product than Department B 104. Accordingly, each department will contain a separate technology silo that is unique to that department. For example, technology silo 108 that is owned and maintained by Department A 102 contains separate and unique products from technology silo 110, owned and maintained by Department B 104. Accordingly, counsel responsible for patents and applications resulting from technology silo 108 via Department A 102 will want to manage the aforementioned IP at the same level. For in-house counsel of Corporation 100 trying to manage the corporation's IP, one intermixed list of all patents and applications of Department A 102 and Department B 104 does him little good. Managing an IP portfolio requires making demarcations at familial and technological relationship boundaries. The value of this is even more pronounced when a single department has multiple technology silos. Department C 106 contains not only technology silo 112 but a second unique technology silo 114. A system that recognizes these relationships is critical for in-house counsel or an IP manager in effectively managing departments and the (sometimes multiple) lines of IP within those departments.

The benefit and utility of viewing patent-related information at the technology-silo level is even more pronounced when viewed through the context of a law firm. As seen in the example shown in FIG. 1B, law firm 200 will have several clients, like Client A 202, Client B 204, and Client C 206 just as corporation 100 had departments 102, 104, and 106. Likewise, Client A 202 brings technology silo 208, Client B 204 brings technology silo 210, and Client C 206 brings technology silo 212 and technology silo 214. The patent practitioner responsible for these clients will need to manage each client's portfolio in an appropriate manner. This means drawing appropriate familial and technological relationship lines. Having a system that organizes the practitioner's work along these boundaries aids the practitioner in both day-to-day tasks, as well as overall client management. For example, a single practitioner within law firm 200 assigned to manage Client A 202, Client B 204, and Client C 206 will find useful an efficient and informative snapshot of the current status, relative application progress, and timeline of future actions of technology silo 208 for Client A 202, technology silo 210 for Client B 204, and technology silos 212 and 214 for Client C 206. Further, detailed information provided in the same interface like budget, family, or other data as requested by the user is likewise useful.

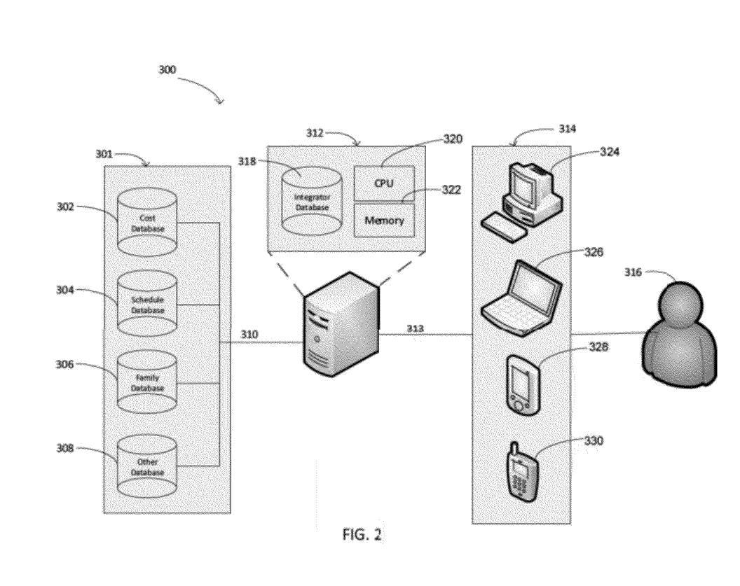

FIG. 2 illustrates an example architecture diagram, according to an embodiment of the present invention. Example system 300 contains, generally, databases 301, an integrator/server 312, and a user interface accessible via any number of terminals or display arrangements 314 by a user 316. It will be understood that the database, servers and terminals or display arrangements can be part of a well-understood computerized systems, either in the form of standalone systems or networked systems, including both intranet and internet systems, as well as virtualized computer processor systems such as cloud computing systems. Likewise, the computer hardware, processors, memory and display systems through with the systems of the present invention can be implemented are intended to extend to any computerized systems that are presently known or that may be developed in the future.

In this embodiment, multiple databases 301 store various patent-related data. Cost database 302 stores costing information in whatever form is relevant to the client and ultimately, the user. Some clients may structure their billing per task, per series of tasks (like securing a patent), or per time period. Schedule database 304 may interface with a docketing system (not shown) to store a particular matter's file history including past and future milestone dates. Family database 306 stores relevant familial and technological data for all matters. Other databases 308 may be added or utilized as necessary. Multiple databases 301 are populated by the respective business module responsible for each particular source. For example, cost database 302 might be populated by the Accounting function of a firm. Schedule database 304 and family database 306 might be populated by the Docketing function. Multiple databases 301 interface to integrator 312 via interface 310. Interface 310 can include calls via IBM DB2 or Oracle RDBMS SQL queries, or any other database interfacing language or appropriate protocol.

Integrator 312 contains integrator database 318 for storing data queried from databases 301 via interface line 310, as well as processor 320 coupled to memory 322. Integrator 312 can include more than one processor 320 which can be distributed across multiple locations. Processor 320 can be embodied by any suitable processor including, without limitation, a RISC or CISC microprocessor, a microcontroller, FPGA, ASIC, or analog processor circuit, for example, and can include single or multiple processing units. Integrator database can be populated by processor 320 in real-time via prompts by user 316, or by batch processing such that the data is populated at known, predefined intervals. Integrator 312 interfaces to the user along interface line 313. Interface line 313 can encompass a wired or wireless network, like an Ethernet network, local area network (LAN), wide area network (WAN) such as the Internet, or a public switched telephone network (PSTN).

Integrator 312 can interface with any number of user displays or terminals 314. User terminal 314 can be embodied by any suitable terminal including, without limitation, a desktop computer 324, laptop computer 326, personal digital assistant (PDA) 328, or smartphone 330.

User 316 accesses terminals 314 over interface 313 to retrieve data stored on integrator database 318 of integrator 312.

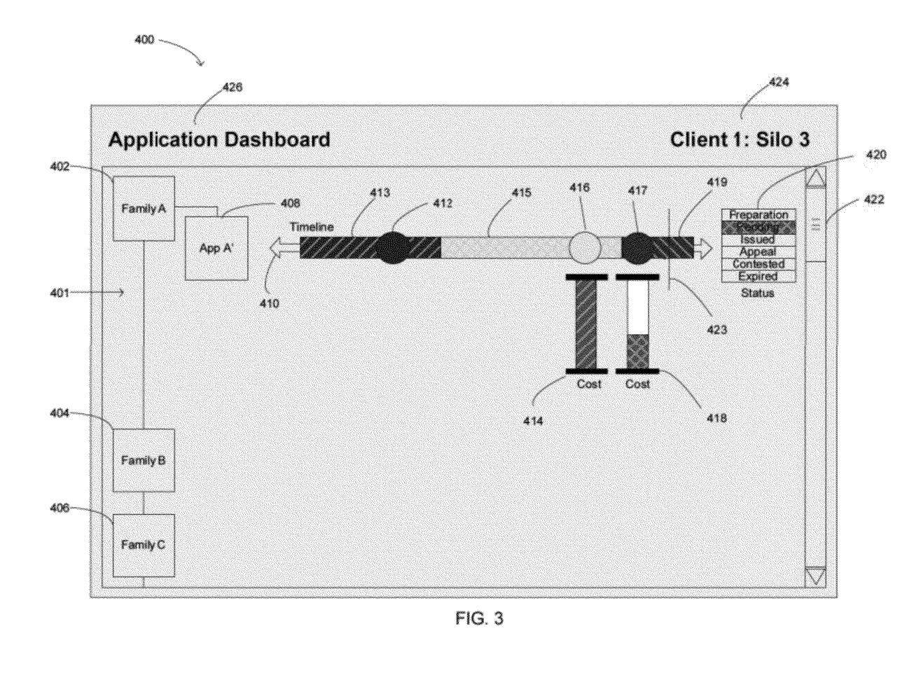

Any of user terminals 314 can be populated with a dashboard interface that allows the user 316 access to data on a plurality of patent prosecution matters in a succinct, useful format. FIG. 3 shows one example dashboard, according to an embodiment of the present invention. Dashboard 400 contains title information 426 as well as client (or department) and silo information 424. The text of client and silo information 424 “Client 1: Silo 3” defines the client name and name of the technology silo currently being viewed. These basic headers allow the user to easily see basic client and silo information. Of course, descriptive naming is useful. Headers 426 and 424 are populated by integrator 312 after initial definition within integrator database 318. Further, dashboard 400 contains scrolling mechanism 422, incorporating up/down arrows for viewing data not currently on the viewable dashboard screen. Substantively, dashboard 400 contains generally a family tree 401, timeline 410 of highlighted applications, and status indication 420.

Each family of patents and applications, i.e. “cases,” in family tree 401 within the viewed technology silo is embodied by a “zoomable” family icon 402. The zoomable family icon 402 allows the user to see various levels of lineage for a specific family by expanding or contracting the level of time relative to the pending and granted applications. The expansion or contraction can be operated by any suitable user interaction, like a mouse wheel scroll or double-click. Further, individual applications 408 can be selected from within the family icon 402. Once highlighted or selected, application 408 appears as a node in a traditional phylogeny tree view. Other families 404 and 406 of the same technology silo are displayed vertically below family 402 and remain in a collapsed but zoomable state until the user highlights individual matters within the family. Capabilities exist to highlight and expand a subset of matters within a family, all matters within a family, or all matters within a technology silo. In an embodiment, international applications associated with a U.S. family are also depicted in family tree 401. In embodiments of system 300, a home country can be selected such that applications or granted patents of countries outside the home country are depicted in the familial visual representation as “foreign” applications. This can be accomplished on the back end by operation of multiple databases 301, via relational connections, for example.

Thus, the user is presented with a unified visual representation of the technology silo by dashboard 400, the families 402, 404, and 406 within a silo, and the matters within a family 408 and can quickly get a sense how the matter at issue relates to all of the aforementioned peer matters.

Once an individual case or matter is selected, a timeline 410 of the relative patent prosecution progress for that case is displayed. Timeline 410 contains any number of patent prosecution events. In the embodiment depicted, prosecution events 412, 416, and 417 are shown. A prosecution event may be, for example, an Office Action received, a Notice of Allowance, or a patent issuing. For each patent prosecution event, an estimated timeframe span for completion, or in the case of an event that is expected from the USPTO, an estimated timeframe span in which the event is expected to be received, is displayed. Event 412 might be the receipt of a first Office Action, for example. Event 412 has related timeframe span 413 in which the estimated timeframe in which the event was expected to be received is represented. Timeframe span 413 shows more span to the left of event 412 than to the right of event 412. Therefore, event 412 was received near the end of the expected timeframe for receipt. Sequentially, next event 416 might be a task to respond to the Office Action of event 412. Related timeframe span 415 shows far more span to the left of event 416 than to the right of event 416. Therefore, event 416 was completed near the end of the time allowed for response. Next, event 417 might be an Issue Fee to be paid. As it was received at the beginning of expected timeframe span 419, the span is only shown as being to the right of the event, representing the time in which the Issue Fee is to be paid, with no span to the left of the event. Current time marker 423 gives an indication of real-world relevance to the prosecution timeline.

Additionally, in this embodiment, for each prosecution event in which time or expense is required of the prosecuting entity, a “thermometer-style” indication of the relative cost for that event is displayed. Cost indication 414 is a visual representation of the calculated expenses relative to the budget for event 416. Cost indication 414 is displayed immediately below event 416, thereby giving the practitioner a snapshot view of where the progress of event 416 should be relative to the budget. In this example embodiment, the thermometer is filled to the top and shaded red, indicating a budget that is completely spent. Cost indication 418 for event 417, conversely, is shaded green and less than half filled, indicating a less-than-half budget spent. In other embodiments not shown, the cost indication may be a “fuel gauge” type visual marker or textual “percentage-based” indication.

In the thermometer embodiment, for example, maximum value, as scaled by the practitioner's charges, is the absolute top of the thermometer, where zero is the absolute bottom of the thermometer. The amount the practitioner has charged to that particular event is the depicted value. For example, an Office Action response with a budget of $5,000 will show an empty progress bar before the practitioner begins his work on the response. Once he has started and charged $2,000, the progress bar will show incremental (roughly 40% filled relative to the top) progress and be green. Once he has charged $4,000, the progress will show 80% progress relative to the top and be yellow. Once he has charged $5,000, the bar will show 100% filled and be red. Further, the progress indication displays useful statistical measurements when the user's mouse hovers above the visual representation, like associate hours spent, law clerk hours spent, etc. These indications allow the practitioner to “see” the event's budget without having to request it from a separate accounting entity or calculate it himself. Effectively, this cost data is put into a readily usable form, thus allowing the practitioner to make decisions and tailor his work based on it.

Once an individual matter or case is selected, a status indication 420 for that matter is displayed. Status indication 420 gives a high-level “executive summary-type” indication of where in prosecution the matter resides. The status indication 420 uses combinations of colors and matrix-based patent progress categories to signal relative health of the matter. The progress categories “Preparation,” “Pending,” “Issued,” “Appeal,” “Contested,” and “Expired” in combination with a red shading to indicate urgency, yellow shading to indicate warning, and green shading to indicate relative health give the user a quick view of status of the matter. In the embodiment depicted in FIG. 3, status indication 420 for matter 408 shows a green shaded “Pending,” thus indicating that the matter is healthily proceeding in prosecution and no current action by the prosecuting entity is required.

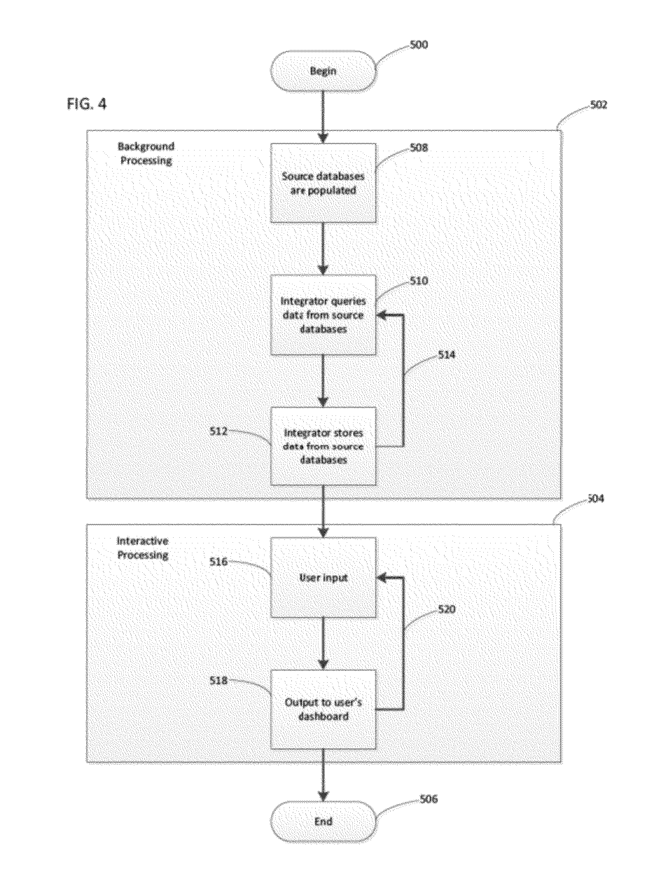

In operation, referring to FIG. 4, system processing begins at 500 and enters background processing at 502. At 508, source databases are populated from their respective local sources. In one example shown in FIG. 2, source databases for cost, schedule, and family are populated. Other databases may be populated if required or desired according to characteristics relevant to the IP owner or prosecuting entity. At 510, the integrator/server queries data from source databases using IBM DB2 or Oracle RDBMS SQL queries, or any other database interfacing language or appropriate protocol in order to store the data in the integrator database at 512. Integrator querying 510 can be conducted real-time via prompts from an integrator administrator, or, more preferably, by batch processing such that the data is populated at known, predefined intervals. The queries are recursively conducted along 514 such that the data in the integrator database is kept up to date with data from the source databases.

Processing then proceeds into the interactive domain at 504 with user input at 516. Depending on what client and technology silo the user wishes to view, an appropriate dashboard is populated with the appropriate families, individual matters, timelines, and statuses. This is output to the user's dashboard for his view at 518. Processing recursively accepts user input at 516 and outputs to the user's dashboard at 518 along 520 until the user exits out of the dashboard at 506 and ends interactive system processing.

### Example 1

In one example, a partner in a patent prosecution law firm, knowing the client he has just transferred to his firm has several pending applications, opens the application dashboard to the new client's page and quickly views the families of applications in the new client's technology silo. He sees that, in Family X, applications '123 and '456 are statused “Pending-yellow” while applications '789 and '012 are statused “Issued-green.” All applications in all other families are statused “Preparation-green.” By simply glancing at the timelines of '123 and '456, he sees that the two Pending-yellow applications require responses to Office Actions. However, judging by the slimmer right side of timeframe span of the Office Action event of '456 than the Office Action event for '123, the partner realizes that application '456 requires more immediate attention than application '123. He then calls an associate attorney to explain that Office Action responses are due in the applications '123 and '456, with '456 more urgent than '123, and asks the associate to look into the exact deadlines and timely prepare the responses. Thus, in no more than a few minutes, from a single application, the partner has been apprised of the status of the new client's applications and has assigned them properly for prosecution.

### Example 2

In another example, an associate attorney in a patent prosecution firm begins his day by opening up the application dashboard to the client and technology silo assigned to him. Today, he knows he must prepare and file an Information Disclosure Statement (IDS) as part of a response to an Office Action he has prepared for his client. The associate opens the family and application at issue and looks to the cost indication for the Office Action response event. He sees that it is three-quarters full and shaded yellow. Thus, he knows that he is nearing his budgeted amount for the response and must work diligently and efficiently to properly finish the task on budget. In order to prepare the IDS, he knows he must at least include all art cited in the same family of applications. To find the proper family, he uses the zoomable family icon to narrow down to the proper family lineage, then captures those matters and forwards that data on to his IDS paralegal for the document preparation. Thus, the associate has investigated his task budget and captured family data easily and efficiently.

### Example 3

In another example, in-house counsel for a large manufacturing corporation arrives at work, knowing he has an 11 AM meeting with the department directors. The meeting is to discuss the current status of the departments' IP portfolios. Instead of spending his whole morning manually sifting through the docket of each matter in every department's portfolio, counsel opens the application dashboard to each department's technology silo to get a sense of the status. For each silo, he selects the plurality of families and drops the timelines and status indications into view. He sees that most of the matters are statused green, but a few are marked yellow. He then scrolls through the timelines, marking on his notes for the meeting a couple of the recent significant events—an issuance and a publication—that he will be happy to tell the directors about. He then realizes that the directors might find the dashboard's succinct, efficient summary of pending matters useful as well and decides to use it as his foundation for talking points in the meeting.

1. A computerized system for the management of patent information, the system comprising:
a familial module adapted to maintain familial data related to at least one patent application;
a schedule module adapted to maintain schedule data related to the at least one patent application;
an integrator comprising:
a processor,
a memory, and
an integrator database configured to store data queried from the familial module and the schedule module by the processor using logic stored in the memory; and
a user terminal adapted to display a dashboard interface to a user, the dashboard interface visually representing the data related to the at least one patent application and comprising:
a family tree icon, the family tree icon visually depicting the familial relations of the at least one patent application,
a timeline, the timeline visually depicting the relative patent prosecution progress of the at least one patent application, and
a status indication icon, the status indication icon visually depicting the relative patent prosecution status of the at least one patent application.

2. The system of claim 1, wherein the familial module comprises a familial database configured to store familial data related to the at least one patent application.

3. The system of claim 1, wherein the familial module comprises routines adapted to access familial-related information via the Internet.

4. The system of claim 1, wherein the schedule module comprises a schedule database configured to store schedule data related to the at least one patent application.

5. The system of claim 1, wherein the schedule module comprises routines adapted to access schedule-related information via the Internet.

6. The system of claim 1, further comprising a cost database, the cost database configured to store cost data related to the at least one patent application, wherein the processor is further configured to query the cost database and store the returned cost data in the integrator database.

7. The system of claim 1, wherein the dashboard interface is displayed to the user on at least one of a desktop computer, a laptop computer, personal digital assistant, tablet, or smartphone.

8. The system of claim 1, wherein the family tree icon is at least one of zoomable, expandable, or contractible by the user and the status indication icon further comprises identification of the at least one patent application in at least one of the categories, “Preparation,” “Pending,” “Issued,” “Appeal,” “Contested,” or “Expired.”

9. The system of claim 1, wherein the timeline further comprises at least one prosecution event, the at least one prosecution event visually depicting an associated event occurring during patent prosecution.

10. The system of claim 9, wherein the timeline further comprises an estimated timeframe span for the at least one prosecution event, the estimated timeframe span visually depicting the relative time range in which the at least one prosecution event should occur.

11. The system of claim 10, wherein the timeline further comprises a current time marker, the current time marker visually depicting the relative current time in relation to the timeline and the at least one prosecution event.

12. The system of claim 9, wherein the dashboard interface further comprises a cost indication icon for the at least one prosecution event, the cost indication icon visually depicting the cost relative to a budget for the prosecution expense of the at least one prosecution event.

13. The system of claim 12, wherein the cost indication icon comprises one of a thermometer-style icon, a fuel-gauge-style icon, or a percentage-based icon, and the cost indication icon is shaded with green to indicate a low spent cost relative to an estimated cost, yellow to indicate an intermediate spent cost relative to the estimated cost, and red to indicate a high spent cost relative to the estimated cost.

14. The system of claim 1, wherein the family tree icon further comprises foreign patent applications and the system further comprises the option to select a home country such that the family tree icon displays patent applications not being prosecuted in the home country as foreign patent applications.

15. A method for the computerized management of patent information, the method comprising:
populating a familial database with familial data related to at least one patent application;
populating a schedule database with schedule data related to the at least one patent application;
querying, by an integrator, data from the familial database;
querying, by an integrator, data from the schedule database;
populating an integrator database with the data returned from the querying, by the integrator, of the familial database and the schedule database;
receiving input from a user, the input related to the display desired by the user of the at least one patent application;
outputting a dashboard interface to the user based on the received input, the dashboard interface visually representing the data related to the at least one patent application and comprising:
a family tree icon, the family tree icon visually depicting the familial relations of the at least one patent application,
a timeline, the timeline visually depicting the relative patent prosecution progress of the at least one patent application, and
a status indication icon, the status indication icon visually depicting the relative patent prosecution status of the at least one patent application.

16. The method of claim 15, further comprising recursively querying, by the integrator, data from the familial database and data from the schedule database.

17. The method of claim 15, further comprising recursively receiving input from the user and outputting a dashboard interface based on the received input.

18. The method of claim 15, further comprising populating a cost database, wherein the dashboard interface further comprises a visual depiction of cost data related to the at least one patent application.

19. The method of claim 15, wherein outputting the dashboard interface further comprises displaying at least one prosecution event, the at least one prosecution event visually depicting an associated event occurring during patent prosecution.

20. The method of claim 19, wherein outputting the dashboard interface further comprises displaying an estimated timeframe span for the at least one prosecution event, the estimated timeframe span visually depicting the relative time range in which the at least one prosecution event should occur.
